(19) United States
(12) Patent Application Publication
(10) Pub. No.: US 2004/0111272 A1
(43) Pub. Date: Jun. 10, 2004

(54) Multimodal speech-to-speech language translation and display

(75) Inventors: Yuqing Gao, Mount Kisco, NY (US); Liang Gu, Elmsford, NY (US); Fu-Hua Liu, Scarsdale, NY (US); Jeffrey Sorensen, New York, NY (US)

Correspondence Address: F. CHAU & ASSOCIATES, LLP, Suite 501, 1900 Hempstead Turnpike, East Meadow, NY, 11554, US

(73) Assignee: International Business Machines Corporation, Armonk, NY

(21) Appl. No.: 10/315,732

(22) Filed: Dec. 10, 2002

(51) Int. Cl. G10L 21/00

(52) U.S. Cl. 704/277

(57) ABSTRACT

A multimodal speech-to-speech language translation system and method for translating a natural language sentence of a source language into a symbolic representation and/or target language is provided. The system includes an input device for inputting a natural language sentence of a source language into the system; a translator for receiving the natural language sentence in machine-readable form and translating the natural language sentence into a symbolic representation and/or a target language; and an image display for displaying the symbolic representation of the natural language sentence. Additionally, the image display indicates a correlation between text of the target language, the symbolic representation and the text of the source language.

The U.S. Government has a paid-up license in this invention and the right in limited circumstances to require the patent owner to license others on reasonable terms as provided for by the terms of Contract No. N66001-99-2-8916 awarded by the Navy Space and Naval Warfare Systems Center.

### BACKGROUND OF THE INVENTION

1. Field of the Invention

The present invention relates generally to language translation systems, and more particularly, to a multimodal speech-to-speech language translation system and method wherein a source language is inputted into the system, translated into a target language and outputted by various modalities, e.g., a display, speech synthesizer, etc.

2. Description of the Related Art

The use of visual images for human communication is very old and fundamental. From the cave paintings to children's drawings today, drawings, symbols and iconic representations have played a fundamental role in human expression. Images and spatial forms are not only used to represent scenes and physical objects but also processes and more abstract notions. Over time, pictographic systems, i.e., visual languages, have evolved into alphabets and symbol systems that depend much more heavily on convention than on likeness for their representational power.

Visual languages are extensively used but in limited domains. For example, traffic symbols and international icons for amenities in public spaces such as telephones, restrooms, restaurants, emergency exits, etc. are well accepted and understood in most parts of the world.

Over the past couple of decades, there has been intense interest in visual languages for human/computer interaction, e.g., graphical interfaces, graphic programming languages, etc. For example, Microsoft's Windows™ interface uses desktop metaphors with folders, file cabinets, trash cans, drawing tools and other familiar objects which have become standard for personal computers, because they make computers easier to use and easier to learn. However, with the global community getter smaller due to ease of travel, improvements in speed of communication mediums, e.g., the Internet, and the globalization of markets, visual languages will play an increasing role in communications between people of different languages. Additionally, visual languages can facilitate communication among those who cannot speak at all, e.g., the deaf, or are illiterate.

Visual languages have a great potential for human-to-human communication because of their following features: (1) internationality—visual languages lack dependence upon a particular spoken or written language; (2) learnability that results from the use of visual representations; (3) computer-aided authoring and display that facilitate use by the drawing-impaired; (4) automatic adaptation (e.g., larger display for the visually impaired, recoloring for the color-blind, more explicit rendering of messages for novices), and (5) use of sophisticated visualization techniques, e.g. animation (See, Tanimoto, Steven L., “Representation and Learnability in Visual Languages for Web-based Interpersonal Communication,” IEEE Proceedings of VL 1997, Sep. 23-26, 1997).

### SUMMARY OF THE INVENTION

A multimodal speech-to-speech language translation system and method for translating a natural language sentence of a source language into a symbolic representation and/or target language is provided. The present invention uses natural language understanding technology to classify concepts and semantics in a spoken sentence, translate the sentence into a target language, and use visual displays (e.g., a picture, image, icon, or any video segment) to show the main concepts and semantics in the sentence to both parties, e.g., speaker and listener, to help users to understand each other and also help the source language user to verify the correctness of the translation.

Travelers are familiar with the usefulness of visual depictions such as those used in airport signs for baggage and taxis. The present invention brings the same features to an interactive discourse model by incorporating these and other such images into a symbolic representation to be displayed, along with a spoken output. The symbolic representation may even incorporate animation to indicate subject/object and action relationships in ways that static displays cannot.

According to an aspect of the present invention, a language translation system includes an input device for inputting a natural language sentence of a source language into the system; a translator for receiving the natural language sentence in machine-readable form and translating the natural language sentence into a symbolic representation; and an image display for displaying the symbolic representation of the natural language sentence. The system further includes a text-to-speech synthesizer for audibly producing the natural language sentence in a target language.

The translator includes a natural language understanding statistical classer for classifying elements of the natural language sentence and tagging the elements by category; and a natural language understanding parser for parsing structural information from the classed sentence and outputting a semantic parse tree representation of the classed sentence. The translator further includes an interlingua information extractor for extracting a language independent representation of the natural language sentence and a symbolic image generator for generating the symbolic representation of the natural language sentence by associating elements of the language independent representation to visual depictions.

According to another aspect of the present invention, the translator translates the natural language sentence into text of a target language and the image display displays the text of the target language, the symbolic representation and the text of the source language, wherein the image display indicates a correlation between the text of the target language, the symbolic representation and the text of the source language.

According to a further aspect of the present invention, a method for translating a language is provided. The method includes the steps of receiving a natural language sentence of a source language; translating the natural language sentence into a symbolic representation; and displaying the symbolic representation of the natural language sentence.

The receiving step includes the steps of receiving a spoken natural language sentence as acoustic signals; and converting the spoken natural language sentence into machine recognizable text.

In another aspect of the present invention, the method further includes the steps of classifying elements of the natural language sentence and tagging the elements by category; parsing structural information from the classed sentence and outputting a semantic parse tree representation of the classed sentence; and extracting a language independent representation of the natural language sentence from the semantic parse tree.

Further, the method includes the step of generating the symbolic representation of the natural language sentence by associating elements of the language independent representation to visual depictions.

In yet another aspect, the method further includes the steps of correlating the text of the target language, the symbolic representation and the text of the source language and displaying the correlation with the text of the target language, the symbolic representation and the text of the source language.

According to another aspect of the present invention, a program storage device readable by a machine, tangibly embodying a program of instructions executable by the machine to perform the method steps for translating a language, the method steps including receiving a natural language sentence of a source language; translating the natural language sentence into a symbolic representation; and displaying the symbolic representation of the natural language sentence.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is block diagram of a multimodal speech-to-speech language translation system according to an embodiment of the present invention;

FIG. 2 is a flowchart illustrating a method for translating a natural language sentence of a source language into an symbolic representation according to an embodiment of the present invention

FIG. 3 is an exemplary display of the multimodal speech-to-speech language translation system illustrating a symbolic representation of a natural language sentence of a source language; and

FIG. 4 is an exemplary display of the multimodal speech-to-speech language translation system illustrating a natural language sentence in a source language, a symbolic representation of the sentence and the sentence translated in a target language with indicators of how the source and target language correlate to the symbolic representation.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A multimodal speech-to-speech language translation system and method for translating a natural language sentence of a source language into a symbolic representation and/or target language is provided. The present invention extends the techniques of speech recognition, natural language understanding, semantic translation, natural language generation, and speech synthesis by adding an additional translation of a graphical or symbolic representation of an input sentence displayed by the device. By including visual depictions (e.g., a picture, image, icon, or video segment), the translation system indicates to the speaker (of the source language) that the speech was recognized and understood appropriately. In addition, the visual representation indicates to both parties aspects of the semantic representation that could be incorrect due to translation ambiguities.

The visual depiction of arbitrary language is in itself a challenge—especially for abstract dialogs. However, due to the natural language understanding processing used in creating a “interlingua” representation, i.e., a language independent representation, during the translation process, additional opportunities to match appropriate images are available. In this sense, a visual language can be considered another target language for the language generation system to target.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), a read only memory (ROM) and input/output (I/O) interface(s) such as keyboard, cursor control device (e.g., a mouse) and display device. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

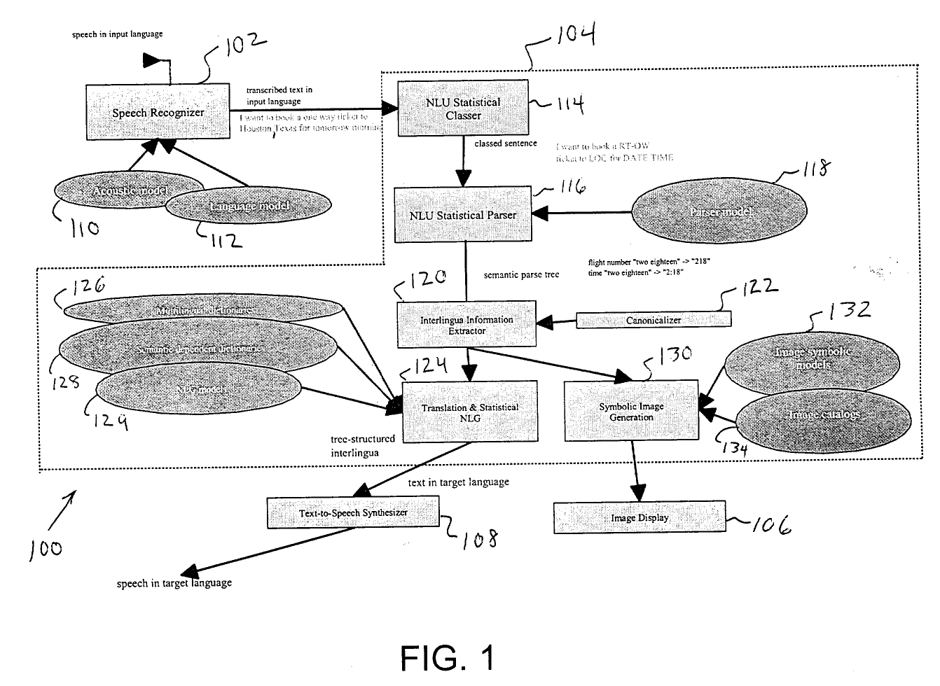

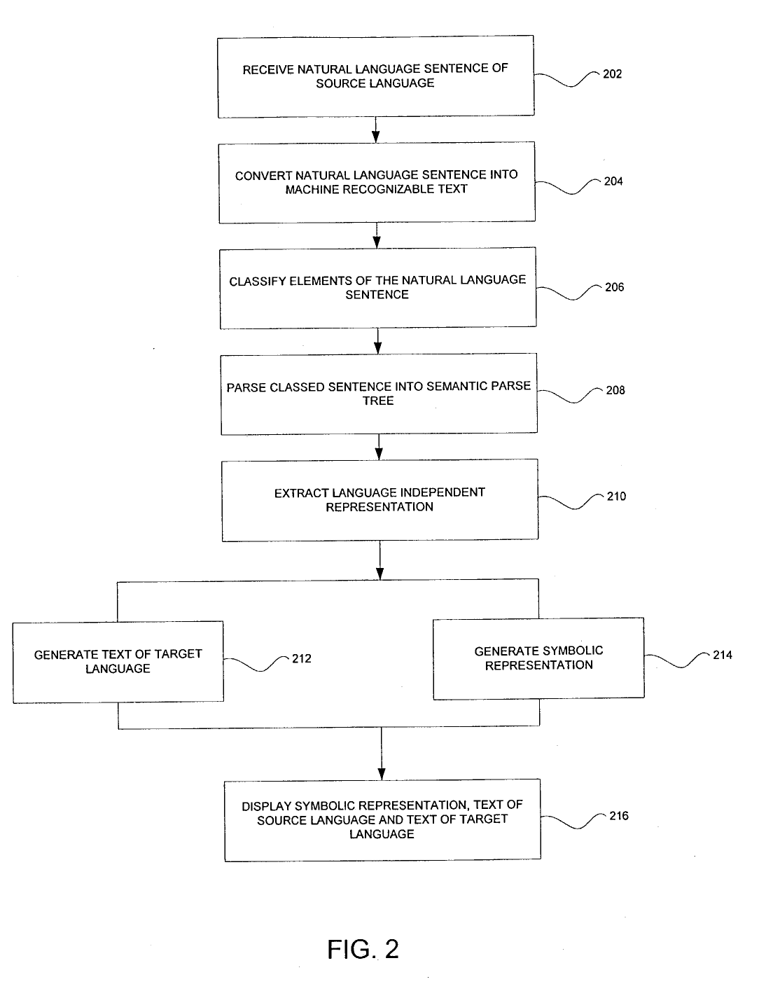

FIG. 1 is a block diagram of a multimodal speech-to-speech language translation system 100 according to an embodiment of the present invention and FIG. 2 is a flowchart illustrating a method for translating a natural language sentence of a source language into a symbolic representation. A detailed description of the system and method will be given with reference to FIGS. 1 and 2.

Referring to FIGS. 1 and 2, the language translation system 100 includes an input device 102 for inputting a natural language sentence into the system 100 (step 202), a translator 104 for receiving the natural language sentence in machine-readable form and translating the natural language sentence into a symbolic representation and an image display 106 for displaying the symbolic representation of the natural language sentence. Optionally, the system 100 will include a text-to-speech synthesizer 108 for audibly producing the natural language sentence in a target language.

Preferably, the input device 102 is a microphone coupled to an automatic speech recognizer (ASR) for converting spoken words into computer or machine recognizable text words (step 204). The ASR receives acoustic speech signals and compares the signals to an acoustic model 110 and language model 112 of the input source language to transcribe the spoken words into text.

Optionally, the input device is a keyboard for directly inputting text words or a digital tablet or scanner for converting handwritten text into computer recognizable text words (step 204).

Once the natural language sentence is in computer/machine recognizable form, the text is processed by the translator 104. The translator 104 includes a natural language understanding (NLU) statistical classer 114, a NLU statistical parser 116, an interlingua information extractor 120, a translation and statistical natural language generator 124 and a symbolic image generator 130.

The NLU statistical classer 114 receives the computer recognizable text from the ASR 102, locates general categories in the sentence and tags certain elements (step 206). For example, the ASR 102 may output the sentence “I want to book a one way ticket to Houston, Tex. for tomorrow morning”. The NLU classer 114 will classify Houston, Tex. as a location “LOC” and replace it in the input sentence. Further, one way will be interpreted to be a type of ticket, e.g., round trip or one way (RT-OW), tomorrow will be replaced with “DATE” and morning will be replaced with “TIME” resulting in the sentence “I want to book a RT-OW ticket to LOC for DATE TIME”.

The classed sentence is then sent to the NLU statistical parser 116 where structural information is extracted, e.g., subject/verb (step 208). The parser 116 interacts with a parser model 118 to determine a syntactic structure of the input sentence and to output a semantic parse tree. The parser model 118 may be constructed for a specific domain, e.g., transportation, medical, etc.

The semantic parse tree is then processed by the interlingua information extractor 120 to determine a language independent meaning for the input source sentence, also known as a tree-structured interlingua (step 210). The interlingua information extractor 120 is coupled to a canonicalizer 122 for transcribing a number represented by text into numerals properly formatted as determined by surrounding text. For example, if the text “flight number two eighteen” is inputted, the numerals “218” will be outputted. Further, if “time two eighteen” is inputted, “2:18” in time format will be outputted.

Once the tree-structured interlingua has been determined, the original input source natural language sentence can be translated into any target language, e.g., a different spoken language, or into a symbolic representation. For a spoken language, the interlingua is sent to the translation & statistical natural language generator 124 to convert the interlingua into a target language (step 212). The generator 124 accesses a multilingual dictionary 126 for translating the interlingua into text of the target language. The text of the target language is then processed with a semantic dependent dictionary 128 to formulate the proper meaning of the text to be outputted. Finally, the text is processed with a natural language generation model 129 to construct the text in an understandable sentence according to the target language. The target language sentence is then sent to the text-to-speech synthesizer 108 for audibly producing the natural language sentence in the target language.

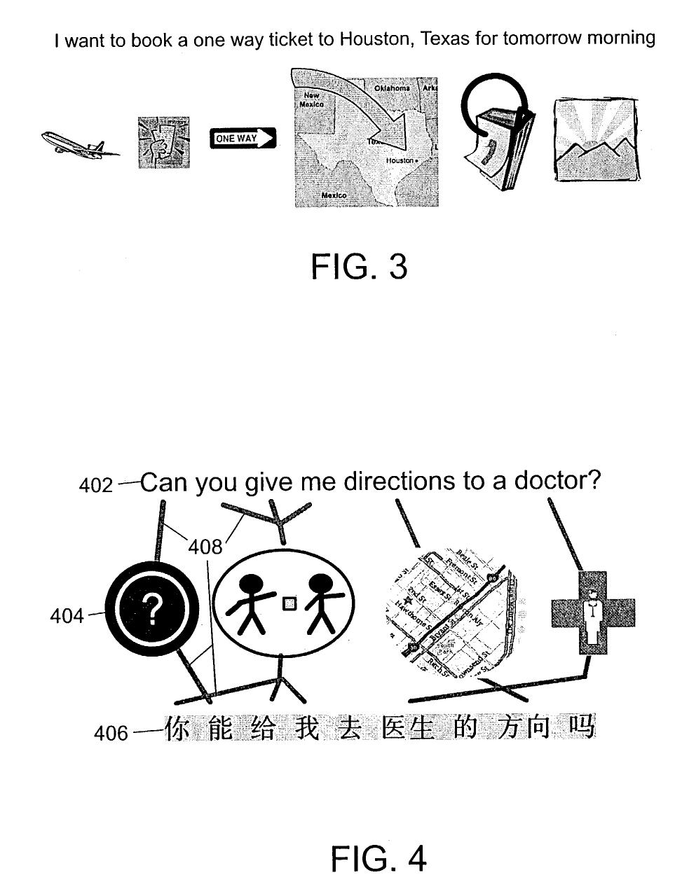

The interlingua is also sent to the symbolic image generator 130 for generating a symbolic representation of visual depictions to be displayed on image display 106 (step 214). The symbolic image generator 130 may access image symbolic models, e.g., Blissymbolics or Minspeak, to generate the symbolic representation. Here, the generator 130 will extract the appropriate symbols to create “words” to represent different elements of the original source sentence and group the “words” together to convey an intended meaning of the original source sentence. Alternatively, the generator 130 will access image catalogs 134 where composite images will be selected to represent elements of the interlingua. Once the symbolic representation is constructed, it will be displayed on the image display device 106. FIG. 3 illustrates the symbolic representation of the original inputted natural language sentence of the source language (step 216).

In addition to the functional benefits of the translation system of the present invention, the user experience for both the speaker and the listener is greatly enhanced by the presence of the shared graphical display. Communication between people who do not share any language is difficult and stressful. The visual depiction fosters a sense of shared experience and provides a common area with appropriate images to facilitate communication through gestures or through a continued sequence of interactions.

In another embodiment of the translation system of the present invention, the symbolic representation displayed will indicate which part of the spoken dialog corresponds to the displayed images. An exemplary screen of this embodiment is illustrated in FIG. 4.

FIG. 4 illustrates a natural language sentence 402 of a source language as spoken by a speaker, a symbolic representation 404 of the source sentence, and a translation of the source sentence 406 into a target language, here, Chinese. Lines 408 indicate the portion of speech the images correspond to in each language, as fluent language translation often requires changes in word ordering. By linking the visual depiction of words and phrases and indicating where in the spoken phrase they occur in each language, the listener can make better use of prosodic cues provided by the speaker, cues that normally are not registered by current speech recognition systems.

Optionally, each image presented on the image display will be highlighted when its corresponding word or concept is audibly produced by the text-to-speech synthesizer.

In another embodiment, the system will detect an emotion of the speaker and incorporate “emoticons”, such as “:-)”, into the text of the target language. The emotion of the speaker may be detected by analyzing the acoustic signals received for pitch and tone. Alternatively, a camera will capture the emotion of the speaker by analyzing captured images of the speaker through neural networks, as is known in the art. The emotion of the speaker will then be associated with the machine recognizable text for later translation.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A language translation system comprising:
an input device for inputting a natural language sentence of a source language into the system;
a translator for receiving the natural language sentence in machine-readable form and translating the natural language sentence into a symbolic representation; and
an image display for displaying the symbolic representation of the natural language sentence.

2. The system as in claim 1, further comprising a text-to-speech synthesizer for audibly producing the natural language sentence in a target language.

3. The system as in claim 1, wherein the input device is an automatic speech recognizer for converting spoken words into machine recognizable text.

4. The system as in claim 1, wherein the translator further comprises
a natural language understanding parser for parsing structural information from the natural language sentence and outputting a semantic parse tree representation of the natural language sentence.

5. The system as in claim 1, wherein the translator further comprises
a natural language understanding statistical classer for classifying elements of the natural language sentence and tagging the elements by category; and
a natural language understanding parser for parsing structural information from the classed sentence and outputting a semantic parse tree representation of the classed sentence.

6. The system as in claim 5, wherein the translator further comprises an interlingua information extractor for extracting a language independent representation of the natural language sentence.

7. The system as in claim 6, wherein the translator further comprises a symbolic image generator for generating the symbolic representation of the natural language sentence by associating elements of the language independent representation to visual depictions.

8. The system as in claim 6, wherein the translator further comprises a natural language generator for converting the language independent representation into a target language.

9. The system as in claim 1, wherein the translator translates the natural language sentence into text of a target language and the image display displays the text of the target language along with the symbolic representation.

10. The system as in claim 3, wherein the translator translates the natural language sentence into text of a target language and the image display displays the text of the target language, the symbolic representation and the text of the source language.

11. The system as in claim 10, wherein the image display indicates a correlation between the text of the target language, the symbolic representation and the text of the source language.

12. A method for translating a language, the method comprising the steps of:
receiving a natural language sentence of a source language;
translating the natural language sentence into a symbolic representation; and
displaying the symbolic representation of the natural language sentence.

13. The method as in claim 12, wherein the receiving step includes the steps of:
receiving a spoken natural language sentence as acoustic signals; and
converting the spoken natural language sentence into machine recognizable text.

14. The method as in claim 13, further comprising the steps of:
parsing structural information from the natural language sentence and outputting a semantic parse tree representation of the natural language sentence.

15. The method as in claim 16, further comprising the step of extracting a language independent representation of the natural language sentence from the semantic parse tree.

16. The method as in claim 13, further comprising the steps of:
classifying elements of the natural language sentence and tagging the elements by category; and
parsing structural information from the classed sentence and outputting a semantic parse tree representation of the classed sentence.

17. The method as in claim 16, further comprising the step of extracting a language independent representation of the natural language sentence from the semantic parse tree.

18. The method as in claim 17, further comprising the step of generating the symbolic representation of the natural language sentence by associating elements of the language independent representation to visual depictions.

19. The method as in claim 18, further comprising the steps of converting the language independent representation into text of a target language and displaying the text of the target language along with the symbolic representation.

20. The method as in claim 19, further comprising the step of audibly producing the text of the target language.

21. The method as in claim 20, further comprising the step of highlighting elements of the displayed symbolic representation corresponding to the audible text of the target language.

22. The method as in claim 19, further comprising the steps of correlating the text of the target language, the symbolic representation and the text of the source language and displaying the correlation with the text of the target language, the symbolic representation and the text of the source language.

23. A program storage device readable by a machine, tangibly embodying a program of instructions executable by the machine to perform the method steps for translating a language, the method steps comprising:
receiving a natural language sentence of a source language;
translating the natural language sentence into a symbolic representation; and
displaying the symbolic representation of the natural language sentence.
